(19) United States
(12) Patent Application Publication
(10) Pub. No.: US 2025/0362680 A1
(43) Pub. Date: Nov. 27, 2025

(54) NAVIGATION MANAGEMENT FOR AUTONOMOUS SYSTEMS

(71) Applicant: Alicia Yau, Falls Church, VA (US)

(72) Inventor: Alicia Yau, Falls Church, VA (US)

(21) Appl. No.: 19/011,605

(22) Filed: Jan. 7, 2025

(51) Int. Cl. G05D 1/246; G05D 101/15; G05D 105/80; G05D 109/12; G05D 111/30

(52) U.S. Cl. CPC G05D 1/246; G05D 2101/15; G05D 2105/87; G05D 2109/12; G05D 2111/32

(57) ABSTRACT

Disclosed herein are methods, devices, systems, and computer programs stored on computer-readable media for managing navigation in autonomous systems. One method includes: determining a route for navigation, communicating with a navigation managing system to determine whether a terrain map for the route is available, and in response to a determination that the terrain map is unavailable at the navigation managing system, navigating the route and generating the terrain map.

### TECHNICAL FIELD

The present disclosure relates generally to autonomous systems, and more particularly, to methods and apparatuses for navigation management for autonomous systems.

### BACKGROUND

Autonomous systems have the potential to revolutionize human activities by performing tasks in hazardous, dynamic, and otherwise inaccessible environments, such as nuclear power plants, construction sites, and wildfire-prone areas. These environments often present new and unpredictable terrains for autonomous systems, requiring advanced capabilities of terrain recognition, navigation, and adaptation to successfully execute each task.

To navigate safely and efficiently, these systems rely on a combination of multiple sensors to collect raw data and complex computational processes to generate detailed terrain maps that capture essential features of the environment, in an effort to allow robots to “perceive” and respond to the terrain in real-time. However, current approaches face significant limitations. Each autonomous system independently collects and processes sensor data, even when multiple autonomous systems operate in the same environment. This redundancy results in wasted computational resources, slower response times, and unnecessary energy consumption. The problem becomes more pronounced in critical emergency scenarios, where swift navigation of uncharted terrains is crucial. Repeating the same process across hundreds of robots exacerbates these inefficiencies, compromising the accuracy, safety, and sustainability of operations.

To address these challenges, there is a pressing need for innovative systems and methods that streamline terrain perception and navigation, ensuring greater efficiency, accuracy, and safety while minimizing resource use. Such advancements could enable autonomous systems to operate collaboratively and sustainably, meeting the demands of both routine and emergency operations.

### SUMMARY

According to some embodiments of the present disclosure, an autonomous system is provided. The autonomous system comprises one or more computer-readable memories storing instructions and one or more processors coupled to the computer-readable memories. The processors are configured to execute the instructions to: determine a route for navigation; communicate with a navigation managing system to verify the availability of a terrain map for the route; and, if the terrain map is determined to be unavailable, navigate the route while generating the terrain map.

According to some embodiments of the present disclosure, a computer-implemented method for an autonomous system is provided. The method includes: determining a route for navigation; communicating with a navigation managing system to verify the availability of a terrain map for the route; and, if the terrain map is determined to be unavailable, generating the terrain map while navigating the route.

According to some embodiments of the present disclosure, a navigation managing system is provided. The navigation managing system includes one or more computer-readable memories storing instructions and one or more processors coupled to the computer-readable memories. The processors are configured to execute the instructions to: receive a request for a terrain map of a navigation route from an autonomous system, the request including one or more parameters associated with the autonomous system; in response to determining that the terrain map is available, provide the terrain map to the autonomous system; or, if the terrain map is unavailable, provide an indication of its unavailability to the autonomous system.

According to some embodiments of the present disclosure, a computer-implemented method for a navigation managing system is provided. The method includes: receiving a request for a terrain map of a navigation route from an autonomous system, the request including one or more parameters associated with the autonomous system; determining whether the terrain map is available in the navigation managing system; if available, providing the terrain map to the autonomous system; or if unavailable, providing an indication of the terrain map's unavailability to the autonomous system.

### BRIEF DESCRIPTION OF DRAWINGS

FIG. 1A and FIG. 1B are schematic diagrams illustrating a terrain information sharing scheme, according to some embodiments of the present disclosure.

FIG. 2A and FIG. 2B are schematic diagrams illustrating a terrain information sharing scheme, according to some embodiments of the present disclosure.

FIG. 3A and FIG. 3B are schematic diagrams illustrating a terrain information sharing scheme, according to some embodiments of the present disclosure.

FIG. 4 is a schematic block diagram of an autonomous system, according to some embodiments of the present disclosure.

FIG. 5 is a schematic diagram illustrating Artificial Intelligence and/or Machine Learning (AI/ML)-based methods for generating and providing terrain maps, according to some embodiments of the present disclosure.

FIG. 6 is a schematic diagram illustrating an example configuration of a terrain map, according to some embodiments of the present disclosure.

FIG. 7 is a schematic diagram illustrating a terrain information providing scheme through a vendor, according to some embodiments of the present disclosure.

FIG. 8 is a schematic diagram illustrating a terrain information providing scheme, according to some embodiments of the present disclosure.

FIG. 9 is a schematic diagram illustrating an exemplary architecture of applying an autoencoder to terrain map provision, according to some embodiments of the present disclosure.

FIG. 10 is a schematic diagram illustrating a method for an autonomous system, according to some embodiments of the present disclosure.

FIG. 11 is a schematic diagram illustrating a method for a navigation managing system, according to some embodiments of the present disclosure.

FIG. 12 is a schematic block diagram of a navigation managing system, according to some embodiments of the present disclosure.

### DETAILED DESCRIPTION

Embodiments of the present disclosure provide methods, devices, and systems for navigation management for autonomous systems. In the methods, an autonomous system may determine a route for navigation, communicate with a navigation managing system to determine whether a terrain map for the route is available; in response to a determination that the terrain map is unavailable at the navigation managing system, generate the terrain map while navigating the route, and send the generated terrain map to the navigation managing system so that the navigation managing system can provide the terrain map to other autonomous systems that navigate the same route.

Embodiments disclosed in the present disclosure have one or more technical effects. In some embodiments, the methods and systems may provide the terrain map generated by an autonomous system to multiple other autonomous systems. This allows multiple other autonomous systems to “see” the terrain before starting the navigation and prepare necessary operations based on the features of the terrain, leading to increased efficiency, safety, and accuracy of the navigation and avoiding waste of resources by eliminating unnecessary computations. In some embodiments, the autonomous system employs artificial intelligence (AI) and/or machine learning (ML) models (collectively referred to as “AI/ML”) to generate a terrain map, wherein the navigation managing system utilizes AI/ML models to optimize and refine the terrain map based on parameters associated with other autonomous systems and/or the navigation history of the autonomous system, thereby enhancing the accuracy and safety of navigation for other autonomous systems. In some embodiments, the autonomous system and the navigation managing system compress the terrain maps to be shared using one or more compression/reconstruction algorithms such as autoencoder. This allows a reduced number of bits of terrain maps to be transmitted, while maintaining the accuracy of the terrain maps, thereby further increasing the navigation's efficiency and minimizing resource waste. In some embodiments, the navigation managing system may customarily generate terrain maps based on requests and continuously update terrain maps using advanced sensors and/or computing systems. This allows autonomous systems to “see” the terrain even if the sensor system of the autonomous system is malfunctioning.

Reference will now be made in detail to exemplary embodiments, examples of which are illustrated in the accompanying drawings. The implementations set forth in the following description of exemplary embodiments do not represent all implementations consistent with the present disclosure. Instead, they are merely examples of systems, devices, and methods consistent with aspects related to the present disclosure as recited in the appended claims.

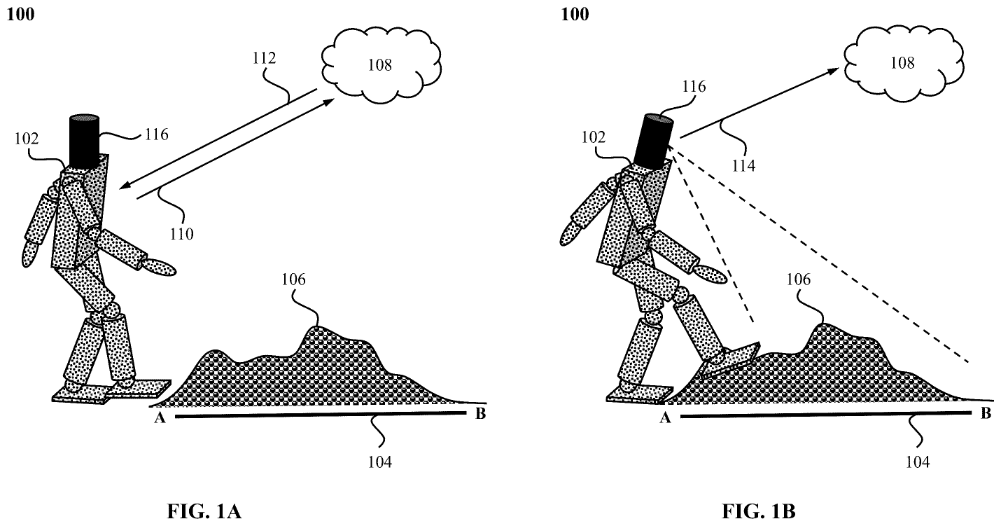

FIG. 1A is a schematic diagram illustrating a scheme for generating and sharing terrain information, according to some embodiments of the present disclosure. Referring to FIG. 1A, an autonomous system (AS) 102 determines a route 104 for navigation between position A and position B of a terrain 106. The term “system” is used broadly in the present disclosure and may refer to any system, device, apparatus, component, or combination thereof. As used herein, the term “system” may encompass hardware, software, firmware, or any combination of these elements. The position can be represented using various coordinate systems, including, but not limited to, global positioning system (GPS) coordinates, spherical coordinates, Euclidean coordinates, cylindrical coordinates, polar coordinates, homogeneous coordinates, barycentric coordinates, curvilinear coordinates, local tangent plane coordinates, affine coordinates, Hilbert space coordinates, and arbitrary reference frames. For example, while FIG. 1A uses biped robots as an illustration, the AS 102 may include, but is not limited to, multilegged systems such as triped robots, quadruped robots, hexapod robots; autonomous vehicles such as self-driving cars and drones; or other machines capable of navigating terrains.

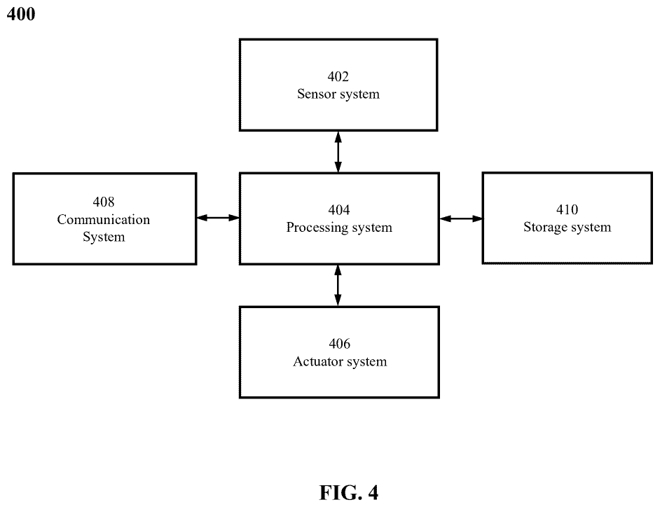

The route 104 may be determined using various methods, such as through a satellite system (e.g., GPS satellites), the internet, or databases stored locally or remotely in a storage system 410 (FIG. 4) associated with the AS 102. Additionally, the route 104 determination may incorporate data from alternative navigation aids, such as beacon signals, local maps, or real-time crowd-sourced information from other autonomous systems in the vicinity.

Once the route 104 is determined, the AS 102 plans the navigation from position A to position B. This planning may involve detailed refinements, such as setting parameters for each servo motor or actuator of the AS 102 to ensure precise control at each segment of the route 104. To one of ordinary skill in the art, such planning may also include optimization algorithms that take into account variables such as energy efficiency, obstacle avoidance, speed, acceleration, and safety.

The AS 102 then communicates with a network node 108 (hereinafter “network 108”) to determine whether the network 108 contains terrain information relevant to the navigation route 104. For instance, the AS 102 may send a request or inquiry signal 110 to the network 108 to check for the availability of a terrain map. The term “terrain map” in the present disclosure is broadly defined and may encompass any format, such as 1-dimensional (1D), 2-dimensional (2D), or 3-dimensional (3D) representations; tabular data with parameters like height, angle, surface texture, obstacle size and location, or stair dimensions (e.g., riser height, tread width, tread depth); binary data sets; or even augmented reality overlays with terrain features. The terrain map may also be overlapped with any other maps. In the present disclosure, the term “terrain map” and the term “terrain information” are used interchangeably.

The request signal 110 may include an indication of the route 104, provided in various formats. For example, the route 104 may be defined by start position A and end position B, by an area or region to be traversed, or by a pre-existing or dynamically generated route on a map. The signal may also include additional information to tailor the response from the network 108. Such information may include, but is not limited to:
Autonomous system-specific attributes: Type, dimensions (e.g., height, leg length, arm length), weight, actuators, battery capacity, ingress protection (IP) rating, or specific functional features like maximum speed, step length, step height, and motor power output.
Environmental conditions: Weather data such as temperature, humidity, precipitation, wind speed, or other relevant parameters.
Operational requirements: The type of work to be performed during navigation, such as load carrying, obstacle manipulation, terrain mapping, or rescue operations.
Dynamic constraints: Real-time data on obstacles, terrain changes, or traffic conditions affecting the route 104.
   For example, the request signal 110 may comprise an indication of the route, and at least one of: a type of the autonomous system, at least one parameter related to weather condition, at least one size of the autonomous system, at least one functional feature of the autonomous system, or a type of work needs to be done by the autonomous system during navigation.

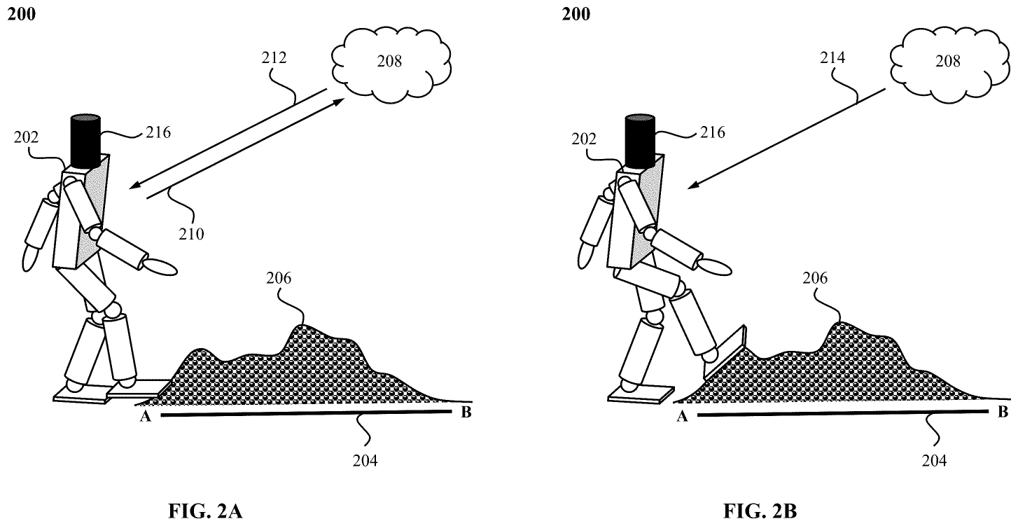

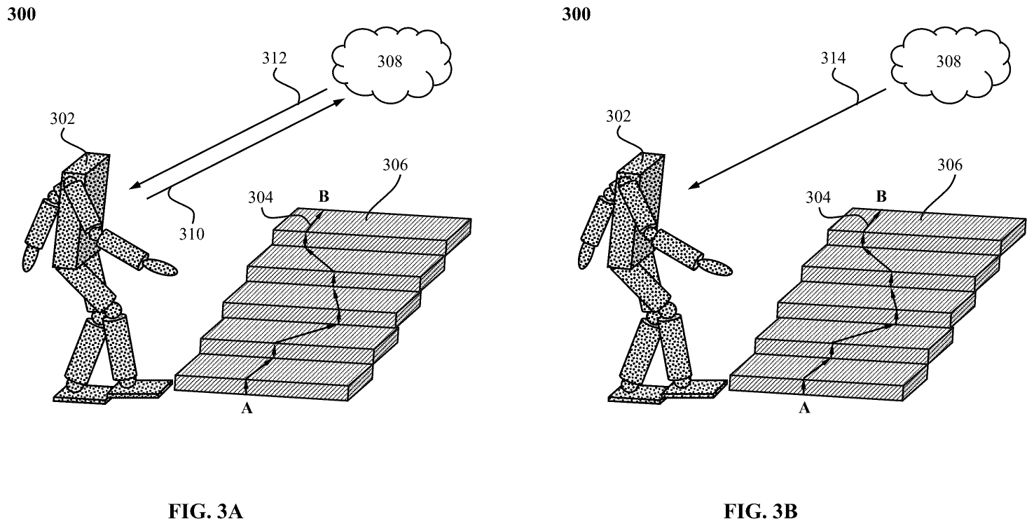

After receiving the request signal 110 from the AS 102, the network 108 may check a storage storing terrain maps. The storage of the network 108 may be a local storage or a remote (e.g., cloud-based) storage. Upon determination that the requested terrain map is unavailable, the network 308 may provide indication of unavailability of the terrain map to the AS 102. For example, the network 108 may send a feedback signal 112 with the indication to the AS 102. For example, the indication may be a single bit “0” or a plurality of bits, depending on the agreement between the network 108 and the AS 102. The AS 102 then sets its navigation mode to a survey mode, collects all possible sensor data through terrain sensing by the sensor system 116 (FIG. 1A and FIG. 1B) during the navigation, and generates the terrain map using the sensor data while navigating the route 104 of terrain 106. The AS 102 then transmits the terrain map data 114 to the network 108 for sharing the terrain map data 114 with the network 108. In this way, after receiving the terrain map data 114 from the AS 102, when other autonomous systems (described in detail in FIGS. 2A, 2B, 3A, and 3B) request the terrain map data for the same route, the network 208, 308 can provide the terrain map 214, 314 to the other autonomous systems so that the other autonomous systems can “see” the terrain before navigation.

FIG. 2A is a schematic diagram illustrating a scheme for providing terrain information, according to some embodiments of the present disclosure. Referring to FIG. 2A, an autonomous system (AS) 202 determines a route 204 for navigation between position A and position B of a terrain 206. For example, while FIG. 2A uses biped robots as an illustration, the AS 202 may include, but is not limited to, multilegged systems such as triped robots, quadruped robots, hexapod robots; autonomous vehicles such as self-driving cars and drones; or other machines capable of navigating terrains.

The route 204 may be determined using a variety of methods, such as through a satellite system (e.g., GPS satellites), the internet, or databases stored locally or remotely in a storage system 410 (FIG. 4) associated with the AS 202. Additionally, the route 204 determination may incorporate data from alternative navigation aids, such as beacon signals, local maps, or real-time crowd-sourced information from other autonomous systems in the vicinity.

Once the route is determined, the AS 202 plans the navigation from position A to position B. This planning may involve detailed refinements, such as setting parameters for each servo motor of the AS 202 to ensure precise control at each segment of the route 204. To one of ordinary skill in the art, such planning may also include optimization algorithms that take into account variables such as energy efficiency, obstacle avoidance, speed, and safety.

The AS 202 then communicates with a network node 208 (hereinafter “network 208”) to determine whether the network 208 contains terrain information relevant to the navigation route 204 of terrain 206. For instance, the AS 202 may send a request or inquiry signal 210 to the network 208 to check for the availability of a terrain map.

The request signal 210 may include an indication of the route 204, provided in various formats. For example, the route 204 may be defined by start position A and end position B, by an area or region to be traversed, or by a pre-existing or dynamically generated route on a map. The signal may also include additional information to tailor the response from the network 208, such as the information described with respect to FIG. 1A and FIG. 1B.

For example, the request signal 210 may comprise an indication of the route, and at least one of: a type of the autonomous system, at least one parameter related to weather condition, at least one size of the autonomous system, at least one functional feature of the autonomous system, or a type of work needs to be done by the autonomous system during navigation.

After receiving the request signal 210 from the AS 202, the network 208 may check a storage storing terrain maps of the terrain 206. The storage may be a local storage or a remote (e.g., cloud-based) storage. Upon determination that the requested terrain map is available, the network 208 may provide an indication of the availability of the terrain map to the AS 202. For example, the network 208 may send a feedback signal 212 with the indication to the AS 202. For example, the indication may be a single bit “1” or a plurality of bits, depending on the agreement between the network 208 and the AS 202.

FIG. 2B shows that the network 208 transmits these data 214 of the terrain map of the terrain 206 to the AS 202. The data 214 includes pre-processed terrain maps, real-time updates, or computed suggestions. Pre-processed maps provide static details like topography, while real-time updates capture dynamic changes such as weather or obstacles, potentially gathered from other systems in the network. Computed suggestions, generated by algorithms or machine learning models, optimize navigation by suggesting efficient routes or maneuvers. The AS 202 integrates with onboard sensor system 216 that includes at least one sensor like LiDAR, ultrasonic sensors, or cameras like computer vision cameras, short-wave infrared (SWIR) camera, and thermal imaging by long-wave infrared (LWIR) camera to enhance situational awareness. This system supports applications such as robotic fleets, autonomous vehicles, and drones operating in complex environments. Since the AS 202 has access to the terrain map 214, it may configure its navigation mode to a speed mode. In this speed mode, as compared to the survey mode, the AS 202 may optimize operational efficiency by presetting a control system for its actuators based on terrain features, selectively deactivating one or more non-critical sensors in the sensor system 216, accelerating on flat or less complex terrain, bypassing certain computational processes, and/or further refining the terrain map during navigation. Additionally, the AS 202 may incorporate predictive modeling to anticipate upcoming terrain conditions, dynamically adjust actuator controls to minimize energy consumption, and prioritize data processing resources for critical navigation tasks. By leveraging these capabilities, the AS 202 can utilize preexisting terrain information to strategically plan and prepare before initiating navigation, ensuring accurate, efficient, and safe operation while maximizing overall performance and resource efficiency.

FIG. 3A and FIG. 3B show another embodiment of the present disclosure that differs from the embodiments shown in FIGS. 1A, 1B, 2A, and 2B. Unlike those embodiments, the embodiment depicted in FIG. 3A and FIG. 3B does not include a sensor system comprising at least one sensor. FIG. 3A is a schematic diagram illustrating a scheme for delivering terrain information, in accordance with certain embodiments of the present disclosure. As shown in FIG. 3A, the AS 302 identifies a route 304 for navigation between position A and position B within a terrain 306. For example, while FIG. 3A uses biped robots as an illustration; the AS 302 may include but is not limited to, multilegged systems such as tripped robots, quadruped robots, hexapod robots; autonomous vehicles such as self-driving cars and drones; or other machines capable of navigating terrains.

The route 304 may be determined using various methods, such as through a satellite system (e.g., GPS satellites), the internet, or databases stored locally or remotely in a storage system 410 associated with the AS 302. Additionally, the route 304 determination may incorporate data from alternative navigation aids, such as beacon signals, local maps, or real-time crowd-sourced information from other autonomous systems in the vicinity.

Once the route is determined, the AS 302 plans the navigation from position A to position B. This planning may involve detailed refinements, such as setting parameters for each servo motor of the AS 302 to ensure precise control at each segment of the route 304. To one of ordinary skill in the art, such planning may also include optimization algorithms that take into account variables such as energy efficiency, obstacle avoidance, speed, and safety.

The AS 302 then communicates with a network node 308 (hereinafter “network 308”) to determine whether the network 308 contains terrain information relevant to the navigation route 304. For instance, the AS 302 may send a request or inquiry signal 310 to the network 308 to check for the availability of a terrain map.

The request signal 310 may include an indication of the route 304, provided in various formats. For example, the route 304 may be defined by start position A and end position B, by an area or region to be traversed, or by a pre-existing or dynamically generated route on a map. The signal may also include additional information to tailor the response from the network 308, such as the information described with respect to FIG. 1A and FIG. 1B. For example, the request signal 310 may comprise an indication of the route, and at least one of: a type of the autonomous system, at least one parameter related to weather condition, at least one size of the autonomous system, at least one functional feature of the autonomous system, or a type of work needs to be done by the autonomous system during navigation.

After receiving the request signal 310 from the AS 302, the network 308 may check a storage storing terrain maps of the terrain 306. The storage may be a local storage or a remote (e.g., cloud-based) storage. Upon determination that the requested terrain map is available, the network 308 may provide an indication of the availability of the terrain map to the AS 302. For example, the network 308 may send a feedback signal 312 with the indication to the AS 302. For example, the indication may be a single bit “1” or a plurality of bits, depending on the agreement between the network 308 and the AS 302.

FIG. 3B shows that the network 308 transmits these data 314 of the terrain map of the terrain 306 to the AS 302. The data 314 includes pre-processed terrain maps, real-time updates, or computed suggestions. Pre-processed maps provide static details like topography, while real-time updates capture dynamic changes such as weather or obstacles, potentially gathered from other systems in the network. Computed suggestions, generated by algorithms or machine learning models, optimize navigation by suggesting efficient routes or maneuvers. The AS 302 does not integrate with any onboard sensor system. This system supports applications such as high-efficiency robotic fleets, autonomous vehicles, and drones operating in static environments. Since the AS 302 has access to the terrain map 314, it may configure its navigation mode to a speed mode. In this speed mode, as compared to the survey mode, the AS 302 may optimize operational efficiency by presetting a control system for its actuators based on terrain features in the terrain data 314, accelerating on flat or less complex terrain, and/or bypassing certain computational processes. By leveraging these capabilities, the AS 302 can utilize preexisting terrain information to strategically plan and prepare before initiating navigation, ensuring accurate, efficient, and safe operation while maximizing overall performance and resource efficiency.

The present disclosure contemplates scenarios where multiple autonomous systems operate collaboratively. For example, one autonomous system (e.g., the AS 102) may map the terrain while another (e.g., the AS 202 or the AS 302) uses the shared map for navigation, reducing computational redundancy and improving efficiency. This collaborative framework may also include prioritization protocols to address emergency situations, ensuring that critical systems receive updates and navigational aids promptly. The disclosed embodiments provide a robust and scalable framework for improving the efficiency, accuracy, safety, and sustainability of autonomous system navigation across diverse terrains and operational contexts.

To one of ordinary skill in the art, the sharing of the terrain data 114, 214, 314 between the AS 102, 202, 302 and the networks 108, 208, 308, respectively in FIGS. 1A, 1B, 2A, 2B, 3A, and 3B, may involve a bidirectional communication process. This process may include, but is not limited to, requesting, confirming, transmitting, acknowledging, and verifying data integrity to ensure successful data exchange. The communication may employ a range of protocols, such as Transmission Control Protocol (TCP), User Datagram Protocol (UDP), or proprietary low-latency protocols optimized for autonomous systems. Additional measures, such as encryption for secure transmission, error correction techniques to ensure data fidelity, and adaptive bandwidth management for efficient resource utilization under varying conditions, may also be implemented. The network 108, 208, 308 may leverage advanced communication technologies, such as 5G, Wi-Fi 6, or satellite-based systems, to enable seamless and reliable data transfer, particularly in remote or challenging environments.

In some embodiments, the network 108, 208, 308 (FIGS. 1A, 11B, 2A, 2B, 3A, and 3B) may operate as a base station (or a combination of the base station and a core network). This base station could be based on existing technologies, such as Long-Term Evolution (LTE) or New Radio (NR), or future-generation technologies like 6th Generation (6G) or beyond. In such configurations, the AS 102, 202, 302 may communicate with the network 108, 208, 308 via a Uu interface. For downlink transmissions, the network 108, 208, 308 act as the transmitter and the AS 102, 202, 302 as the receiver, while for uplink transmissions, the roles are reversed. The AS 102, 202, 302 may transmit reference signals, such as those on the Physical Uplink Shared Channel (PUSCH) or Physical Uplink Control Channel (PUCCH), to query the network 108, 208, 308 regarding the availability of a terrain map. These signals and their formats may adhere to standards established by the 3rd Generation Partnership Project (3GPP). In addition, satellite networks may function as extended base stations, offering continuous coverage and enabling communication in areas beyond the reach of terrestrial networks, such as mountainous regions, oceans, or sparsely populated areas.

In another embodiment, the network 108, 208, 308 may be an access point for a Wireless Local Area Network (WLAN). Communication between the network 108, 208, 308 and the AS 102, 202, 302 may utilize WLAN technologies such as Wi-Fi, following standards established by the Institute of Electrical and Electronics Engineers (IEEE).

For example, the network 108, 208, 308 could serve as an autonomous system manager within an organization or community, managing terrain maps for specific geographic areas. A construction company, for instance, could use the network 108, 208, 308 to collect, maintain, and distribute terrain maps shared by its robot workers to optimize operations. Similarly, satellite-enabled WLAN systems could be employed to facilitate communication and terrain data sharing in isolated or dynamically changing environments, such as disaster zones or large-scale agricultural operations.

In another embodiment, the network 108, 208, 308 may function as a roadside unit (RSU) to assist autonomous systems. The term “roadside unit” encompasses any device installed along roadways and provides support to autonomous systems, including robots. Communication between the AS 102, 202, 302 and the network 108, 208, 308 may utilize short-range technologies, such as Dedicated Short-Range Communication (DSRC), or satellite-based solutions for broader coverage. RSUs could transmit localized terrain updates, traffic conditions, or hazard alerts in real-time, enhancing the safety and efficiency of navigation for autonomous systems. Satellite RSUs, positioned in low Earth orbit (LEO) or geostationary orbit, could complement terrestrial RSUs by offering wide-area support, ensuring uninterrupted connectivity and access to updated terrain data even in areas lacking physical roadside infrastructure.

In some embodiments, the sharing of terrain map data 114 between the AS 102 and the network 108 (FIG. 1B), and/or the sharing of terrain map data 214, 314 between the network 208, 308 and the AS 202, 302, may operate as a fee-based service. For example, the network 208 (or the network 308) may charge the AS 202 (or the AS 302) a service fee for providing access to the terrain map, and/or the network 108 may pay the AS 102 for supplying the terrain map data 114. This fee-based model can incentivize the generation and sharing of high-quality terrain data while supporting the operational costs of the network and autonomous systems.

In some embodiments, the generated terrain map 114 is provided in real time. For example, the AS 102 may continuously transmit portions of the terrain map data 114 during navigation, while the network 108 simultaneously shares these received portions with other autonomous systems (not shown in FIG. 1B). This corresponds to the scenario depicted in FIG. 1B, where the AS 102 shares terrain map data 114 with the network 108 concurrently with the scenarios in FIG. 2B or FIG. 3B, where AS 202 or AS 302 receive terrain map data 214 or 314 from their respective networks.

FIG. 4 is a schematic block diagram of an autonomous system, according to some embodiments of the present disclosure. Referring to FIG. 4, an autonomous system 400 includes a sensor system 402, a processing system 404, an actuator system 406, a communication system 408, and a storage system 410. The sensor system 402 may include any number, any type of sensor capable of capturing, measuring, and/or sensing data associated with the autonomous system and the environment of the autonomous system. For example, the sensor system 402 may include at least one of: one or more image-capturing devices (e.g., cameras), a global positioning system (GPS), a light detection and ranging (LIDAR), a radar, a speed sensor, an accelerometer, a gyro sensor, a suspension sensor, an acoustic sensor, or an inertia sensor.

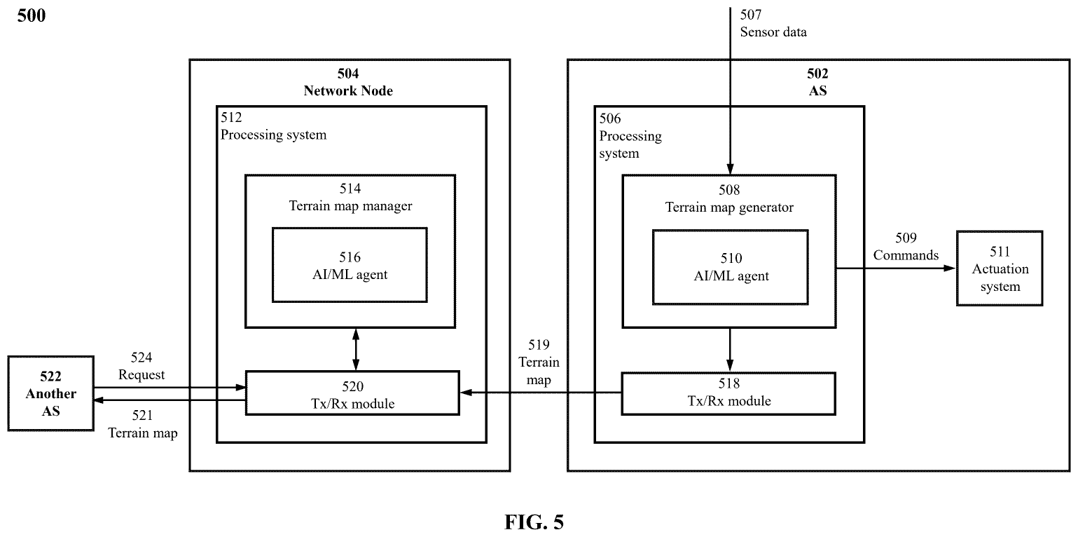

The processing system 404 may include one or more processors that can process the sensor data obtained by the sensor system 402. The one or more processors may include one or more hardware devices with processing capabilities, such as general-purpose processors, digital signal processors, central processing units (CPUs), graphical processing units (GPUs), microcontrollers, an application specific integrated circuit (ASIC), a field programmable gate array (FPGA), a programmable logic device, a discrete gate or transistor logic component, a discrete hardware component, or other programmable logic device. The processing system 404 may also include at least one computer-readable storage medium that stores computer-readable program (software) for the one or more processors. The one or more processors may execute the program to control various operations of the autonomous system. One of the operations is to process the sensor data to generate terrain map, and plan the navigation of the autonomous system, as discussed in detail with respect to FIG. 5. In some embodiments, at least a portion of the processing system 404 is disposed remotely so that some computations are performed remotely (e.g., cloud computing).

The actuator system 406 may include one or more actuators, motors, and controllers. For example, in an embodiment, the autonomous system may be a biped robot, and each joint of the robot is provided with one or more actuators (e.g., ball screw actuators, hydraulic actuators, gear-based drivetrain, etc.) and the motors of the actuators. The processing system 404 may control the actuator system 406 based on the terrain map and the navigation plan generated at the processing system 404 using the sensor data.

The communication system 408 may include one or more antennas and one or more transceivers (receivers and transmitters) that are configured to communicate with other devices. The antenna may be used for transmission or reception of electromagnetic signals to/from one or more other devices (e.g., the network 108, 208, 308). The antenna may include one or more antenna elements and may enable different input-output antenna configurations, for example, multiple input multiple output (MIMO) configuration, multiple input single output (MISO) configuration, and single input multiple output (SIMO) configuration. In some embodiments, the antenna may include multiple antenna elements and may enable multi-antenna functions such as beamforming. In some embodiments, the antenna is a single antenna.

The storage system 410 may include one or more storage devices. Examples of the storage devices may include, but are not limited to, solid state device, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage, a portable computer diskette, or a hard disk. In some embodiments, the storage system 410 is one or more local storage devices that are disposed inside the autonomous system. In some embodiments, at least part of the storage system 410 is a cloud-based storage that is located remotely. The storage system 410 may store one or more AI/ML models that are used for generating terrain maps.

FIG. 5 is a schematic diagram illustrating AI/ML based methods for generating and providing terrain maps, according to some embodiments of the present disclosure. Referring to FIG. 5, an AS 502 plans to navigate a terrain, generate a terrain map during navigation, and share the terrain map with a network node 504. The AS 502 includes a processing system 506. The processing system 506 may be similar to the processing system 404 of FIG. 4. The processing system 506 includes a terrain map generator 508 that receives sensor data 507 collected by a sensor system (not shown), such as the sensor system 404 of FIG. 4, and generates a terrain map based on the sensor data 507. The collected sensor data 507 may include features related to the terrain, such as elevations, surface conditions, slant angles, obstacles, stairs, and other relevant features.

In some embodiments, the terrain map generator 508 includes an AI/ML agent 510 that takes the responsibility of terrain map generation using one or more AI/ML models and makes the decision on navigation plan and parameters. The term “AI/ML agent” described in the present disclosure may include any agent that uses artificial intelligence techniques and/or machine learning techniques for decision-making. The AI/ML agent described in the present disclosure may be software, hardware, or a combination of software and hardware. The AI/ML agent may select an algorithm to process the sensor data 507. For example, the AI/ML agent may select a deep learning that uses artificial neural networks, such as a convolutional neural network (CNN), to analyze the image data obtained by one or more image sensors to recognize and extract patterns in the image data. Other AI/ML models that currently exist or developed in the future may also be used to process the sensor data 507. Examples of the AI/ML models may include, but are not limited to, light gradient boosting machines (LightGBM), gated recurrent units (GRUs), recurrent neural networks (RNNs), long short-term memory (LSTM) models, and k-nearest neighbor (kNN) models.

Based on the analysis of the sensor data 507, the terrain map generator 508 generates one or more terrain maps. For example, the terrain map generator 508 may generate at least one of: a 1D map, a 2D map, a 3D map, a color map, a table of parameter values indicating terrain features, or multiple sets of binary values indicating terrain features, etc. The terrain features may include, but are not limited to, position, height, angle, surface smoothness/roughness, surface texture, obstacle location, obstacle size, obstacle texture, staircase riser height, tread width, tread depth, etc. The terrain map generator 508 may further adjust/optimize the navigation route and the navigation parameters (e.g., running, walking, stopping, turning right/left a certain angle, moving right/left, stair climbing, traversing obstacles, step height, stride length, cadence, speed, acceleration, etc.). Based on the navigation route and the navigation parameters, the processing system 506 may send commands/instructions 509 to an actuation system, such as the actuation system 511 of FIG. 5, to control the movement of the AS 502.

In some embodiments, the terrain map generator 508 further sends the generated terrain map to the network node 504. For example, as shown in FIG. 5, the terrain map generator 508 sends the terrain map data 519 through transmission/reception (Tx/Rx) module 518 to the Tx/Rx module 520 of a processing system 512 of the network node 504. The processing system 512 of the network node 504 includes a terrain map manager 514. The terrain map manager 514 may classify, store, refine, update terrain maps for various autonomous systems and provide the terrain maps to any autonomous system that requests terrain maps. For example, as shown in FIG. 5, another autonomous system AS 522 requests data of a terrain map 521 for the same route as the AS 502, and the terrain map manager 514 may transmit the terrain map data 519 received from the AS 502. Before transmitting the terrain map data 519 to the AS 522, the terrain map manager 514 may refine/adjust the terrain map 519 based on the parameters associated with the AS 522. The parameters associated with the AS 522 may be included in the request 524 received from the AS 522. The examples of the parameters associated with AS 522 may include, but are not limited to, at least one of a type of the autonomous system, at least one parameter related to weather condition, at least one size of the autonomous system, the height of the AS, the length of the legs, the size of the feet, the battery capacity, the motor output power, at least one functional feature of the autonomous system, or a type of work needs to be done by the autonomous system during navigation.

In some embodiment, the terrain map manager 514 includes an AI/ML agent 516 that optimizes and updates the terrain map 519 received from the AS 502 and other autonomous systems. For example, the AI/ML agent 516 may use machine learning techniques, such as reinforcement learning, to optimize the terrain map received from the AS 502 for another AS 522 based on the parameters associated with the AS 522 and/or the navigation history (e.g., falling, skidding, colliding with obstacles, etc.) of the AS 502. For another example, the AI/ML agent 516 may use Bayesian network to optimize the terrain map for another AS and recommend a navigation plan for another AS. In some embodiments, the AI/ML agent 516 may convert a terrain map obtained from one autonomous system to another terrain map applicable to another autonomous system. For example, the AI/ML agent 516 may convert a terrain map obtained by a biped robot to a terrain map applicable to a quadruped robot. The AI/ML agent 516 may use any AI/ML models that currently exist or developed in the future to optimize and update the terrain maps, or plan navigations for autonomous systems. Other examples of the AI/ML models may include, but are not limited to, hidden Markov models, influence diagrams, Gaussian process, Dirichlet process, and Bayesian neural network, etc.

In some embodiments, instead of sending the generated terrain map 519, the AS 502 may send the raw sensor data 507 to the network node 504 or upload the raw sensor data 507 to a certain storage device so that the network node 504 may process the raw sensor data 507 and generate a terrain map. The network node 504 may use one or more AI/ML models that are the same as or different from the AI/ML model(s) used by the AI/ML agent 510 of the AS 502. The AS 502 may send the raw sensor data 507 voluntarily or in response to a request from the network node 504. In some embodiments, the raw sensor data 507 obtained by AS 502 are stored in a cloud-based storage so that the network node 504 can access the raw sensor data from the cloud-based storage. The network node 504 may access the raw sensor data with or without the permission of the AS 502.

In some embodiments, the autonomous systems are standardized. For example, in the case of biped humanoid robot, the size of the robot (e.g., height, length of the legs), the weight of the robot, the components (e.g., sensor systems, actuation systems, battery, motors, etc.) can be standardized so that a terrain map applicable to one robot can be applied to many other robots with the same type. In this case, the AI/ML agent 516 may categorize terrain maps and recommended navigation plans based on the types of autonomous systems. An autonomous system may just provide its type to the network node 504 and the network 504 can provide a corresponding terrain map and/or recommended navigation plan.

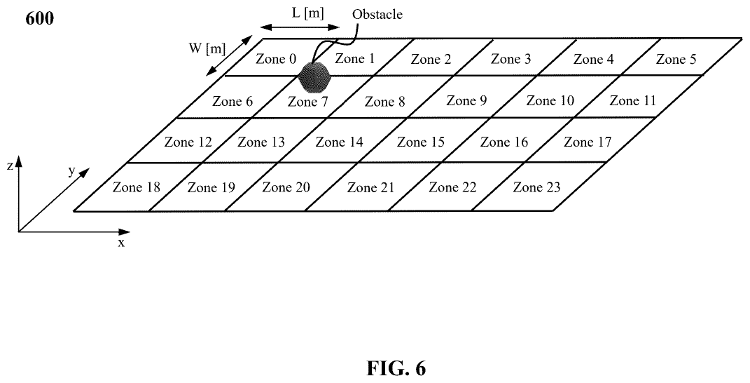

FIG. 6 is a schematic diagram illustrating an example configuration of a terrain map, according to some embodiments of the present disclosure. As shown in FIG. 6, in some embodiments, a plurality of 2D zones is configured for a terrain map. Each zone has a unique identification (ID) number (e.g., 0, 1, 2, 3, 4, . . . ). Each dimension, for example, a length L in x-direction (e.g., 1 m) and a width W in y-direction (e.g., 1 m) are also configured. The zone dimensions L and W can be any other number, for example, smaller than 1 m or larger than 50 m. In some embodiments, if a large obstacle (e.g., an obstacle occupies at least half of a zone) is in a zone, the entire zone may be indicated as an obstacle zone. In some embodiments, if a small obstacle (e.g., an obstacle occupies less than half of a zone) is in a zone, such as the obstacle in the zone 7 of FIG. 6, the obstacle may be identified by its shape, size, and the location in the zone, and the rest of the zone 7 can be indicated as safe area. In some embodiments, surface smoothness/roughness of a zone may be indicated as an average smoothness/roughness value of an entire zone. The surface smoothness/roughness may be rated, for example, from 1 to 10, 10 indicating a very smooth surface, while 1 indicating a very rough surface. The rating can be any range of numbers, for example, from 1 to 100, from 1 to 1000, etc. In some embodiments, the different surface smoothness/roughness can be represented with different colors applied to the zones on the terrain map.

In some embodiments, the terrain map may use a standardized map format so that different autonomous systems can “see” the same terrain map for the same terrain. The standardized map format may be developed by a standard setting organization.

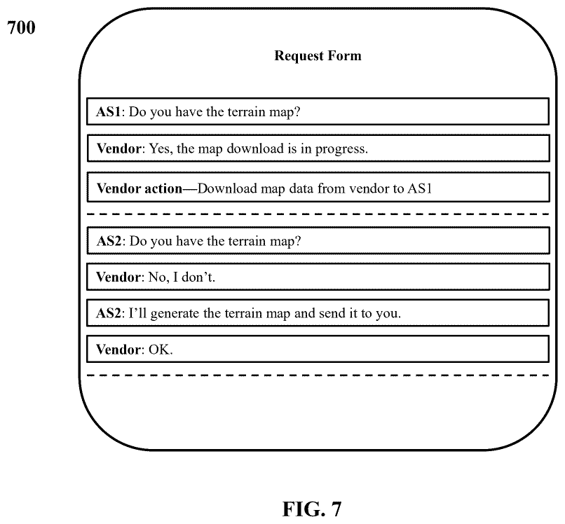

FIG. 7 provides a schematic diagram illustrating an interface or a user interface for a terrain information provisioning scheme, according to some embodiments of the present disclosure. As depicted in FIG. 7, the network node of a vendor includes a user interface 700. The autonomous system AS1 communicates with the vendor via the interface 700, with the communication history recorded in a Request Form. The AS1 may input an inquiry on a user interface 700 provided by the navigation managing system, the inquiry comprising an indication of the route, and at least one of: a type of the autonomous system AS1, at least one parameter related to weather condition, at least one size of the autonomous system AS1, at least one functional feature of the autonomous system AS1, or a type of work needs to be done by the autonomous system AS1 during navigation. For example, in this Request Form, the AS1 additionally transmits an inquiry in the form of a communication line, such as “Do you have a terrain map?” or a predefined program code agreed upon by the AS1 and the vendor in the interface 700.

Upon receiving the inquiry through the interface 700, the vendor verifies whether the requested terrain map is stored within its local or remote storage system. If the terrain map is available, the vendor transmits a response to the AS1 in the form of a communication line, such as “Yes, the map download is in progress,” or an agreed-upon program code. Subsequently, the vendor initiates the transfer of the terrain map data to the AS1.

In FIG. 7, another example of communication history between an AS2 and the vendor via interface 700 is also shown. Specifically, the AS2 transmits an additional inquiry in the form of a communication line, such as “Do you have the terrain map?” or a predefined program code agreed upon by the AS2 and the vendor via interface 700. Upon receiving the request from the AS2, the vendor checks its local or remote storage system for the requested terrain map. If the terrain map is unavailable, the vendor sends a response to the AS2 in the form of a communication line, such as “No, I don't,” or an agreed-upon program code. In response, the AS2 may transmit a follow-up communication line, such as “I'll generate the terrain map and send it to you,” or an agreed-upon program code. To confirm acceptance of the incoming data, the vendor responds with a communication line, such as “OK,” or an agreed-upon program code.

The interaction shown in FIG. 7 can occur in scenarios depicted in FIGS. 2A, 2B, 3A, and 3B for the AS1, and in FIGS. 1A and 1B for the AS2, when the network node is operated by a vendor. The detailed mechanisms described in FIGS. 1A, 1B, 2A, 2B, 3A, and 3B are therefore applicable to FIG. 7 and are not repeated here for brevity.

The vendor may implement a flexible payment structure for its services. For instance, users may opt for a one-time payment for individual services or subscribe to a monthly or yearly plan that offers a specific number of services within the chosen period. Additionally, to enhance its terrain map database, the vendor can collaborate with autonomous systems by purchasing terrain maps from AS devices or acquiring maps from other vendors via the Internet. In cases where the vendor does not possess a requested terrain map, it can incentivize AS systems to generate and provide the required map, thereby enriching its database and expanding its service offerings.

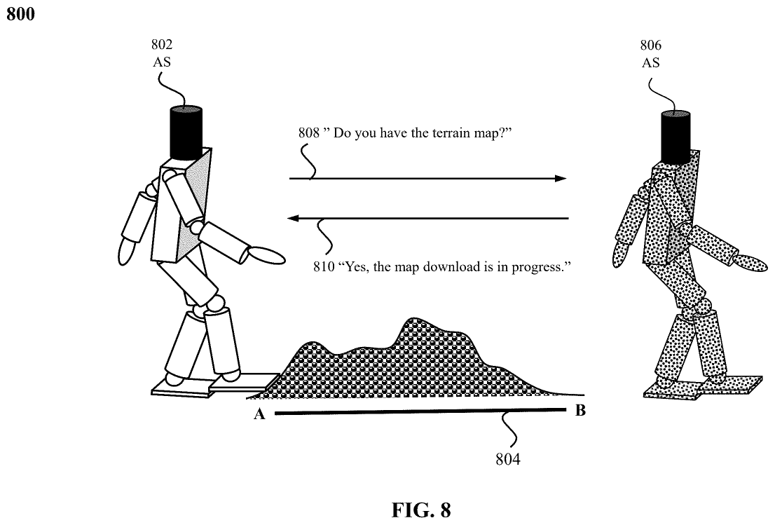

FIG. 8 is a schematic diagram illustrating a terrain information providing scheme, according to some embodiments of the present disclosure. As shown in FIG. 8, a communication system 800 includes an AS 802 and an AS 806. Unlike FIGS. 1A, 1B, 2A, 2B, 3A, and 3B, FIG. 8 illustrates the two autonomous systems (the AS 802 and the AS 806) sharing terrain information directly, without involving a third party such as a network node or vendor. In particular, the AS 806 is the first robot that collects sensor data and generates a terrain map while navigating the terrain, while the AS 802 is a second robot that transmits a request 808 to the AS 806. The request signal 808 can be a communication line, such as “Do you have the terrain map?” or a predefined program code agreed upon by the AS 802 and the AS 806. The request signal 808 may be the same as that in FIGS. 1A, 2A, and 3A, and may comprise an indication of the route, and at least one of: a type of the autonomous system, at least one parameter related to weather condition, at least one size of the autonomous system, at least one functional feature of the autonomous system, or a type of work needs to be done by the autonomous system during navigation. The AS 806, in response to the received request 808, may provide a response 810 to the AS 802. The response 810 can be a communication line such as “Yes, the map download is in progress.” or a predefined program code agreed upon by the AS 802 and the AS 806. Then, the AS 802 receives the terrain map from the AS 806 and uses it for navigation. The AS 802 may optimize the terrain map based on the parameters (physical parameters, weather conditions, etc.) associated with it. The AS 802 may communicate with the AS 806 using any of known communication methods, for example, cellular communication, wireless local area communication, satellite communication, etc. The process of generating and providing the terrain map is similar to that described above with respect to FIGS. 1A, 1B, 2A, 2B, 3A, and 3B. For the sake of simplicity, the detailed process is omitted here.

One practical challenge in terrain map sharing is that the size of the generated terrain map is large. For example, in FIG. 1B (or FIG. 7 or FIG. 8), in order to precisely describe the features of a terrain, the AS 102 (or the AS2 in FIG. 7 or the AS 806 in FIG. 8) may need to use a large number of bits in transmitting the terrain map to the network 108 (or the vendor in FIG. 7 or the AS 802 in FIG. 8). At least some embodiments of the present disclosure address this challenge by providing terrain map compression that allows the use of a fewer number of bits to transmit terrain maps. For example, in some embodiments, an autonomous system (or a network node or a vendor) may use an encoder of an autoencoder to compress a terrain map and use a decoder of the autoencoder to reconstruct the terrain map. The term “autoencoder” described in the present disclosure may include any artificial neural network that learns to compress and reconstruct input data. The autoencoder described in the present disclosure may be software, hardware, or a combination of software and hardware.

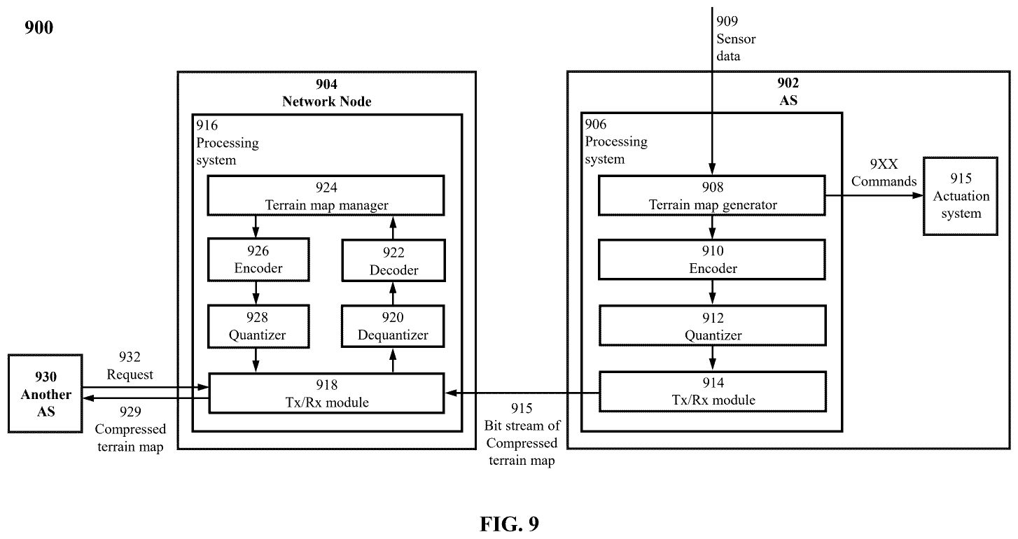

FIG. 9 is a schematic diagram illustrating an architecture of applying an autoencoder to terrain map provision, according to some embodiments of the present disclosure. As shown in FIG. 9, an AS 902 includes a processing system 906 that includes an encoder 910 of an autoencoder. A network node 904 includes a processing system 916 that includes a decoder 922 of the autoencoder. The processing system 906 of the AS 902 also includes a terrain map generator 908 that generates a terrain map using sensor data 909 collected by a sensor system (not shown). The process of generating the terrain map by the terrain map generator 908 is similar to the process at the 508 of FIG. 5. For the sake of simplicity, the process of generating the terrain map at the terrain map generator 908 is omitted here. As shown in FIG. 9, the generated terrain map is fed to the encoder 910. The encoder 910 then compresses the terrain map information (data) to low dimensional information. The low dimensional information is then fed to a quantizer 912 to transform the low dimensional information to a bit stream having a certain number of bits. The generated bit stream then fed to a Tx/Rx module 914 of the AS 902 for transmission. The Tx/Rx module 914 then transmits the bit stream 915 of the compressed terrain map to the Tx/Rx module 918 of the network node 904. The term “module” described in the present disclosure can be pure software, pure hardware, or a combination of software and hardware.

At the network node 904, the bit stream 915 is fed from the Tx/Rx module 918 to a dequantizer 920 to transform the bit stream 915 to low dimensional information. A decoder 922 of the network node 904 then reconstructs a high-dimensional terrain map using the low dimensional information and outputs the reconstructed terrain map to a terrain map manager 924. The terrain map manager 924 may optimize the terrain map based on the request received from another AS (AS 930). The process of optimization performed at the terrain map manager 924 may be similar to the process performed at the terrain map manager 514 of FIG. 5. For the sake of simplicity, the process at the map manager 924 is omitted here. The optimized terrain map is then fed to an encoder 926 of the network node 904. The encoder 925 then compresses the terrain map information (data) to low dimensional information. The low dimensional information is then fed to a quantizer 928 to transform the low dimensional information to a bit stream having a certain number of bits. The generated bit stream then fed to the Tx/Rx module 918 of the network node 904 for transmission. The Tx/Rx module 918 then transmits the bit stream 929 to another AS 930 that transmitted a request 932 for a terrain map.

Although FIG. 9 explains the application of the autoencoder between an autonomous system and a network node, the scope of the present disclosure is not so limited. The same concept can be applied to terrain map sharing between two autonomous systems, or between vendor and an autonomous system.

Autoencoder is merely an exemplary technique for data compression/reconstruction, and the embodiments of the present disclosure are not so limited. Any data compression/reconstruction techniques or algorithms currently known or developed in the future can be implemented in the embodiments of the present disclosure.

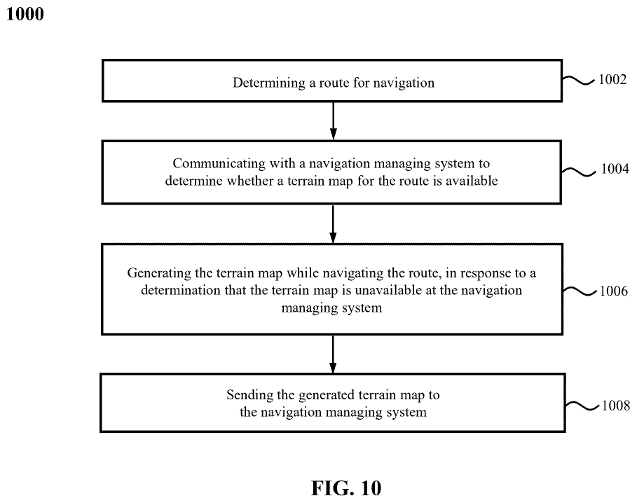

FIG. 10 is a schematic diagram illustrating a method for an autonomous system, according to some embodiments of the present disclosure. The autonomous system may be an autonomous system that generates a terrain map during navigation, such as the AS 102 of FIG. 1B, the AS2 of FIG. 7, and AS 806 of FIG. 8. Referring to FIG. 10, a method 1000 includes a step 1002 of determining a route for navigation. For example, the autonomous system may determine a start point and an end point of a route. If there is a known road between the start point and the end point, the autonomous system may preliminarily select the road as the route. The autonomous system may also use known maps to determine the route.

The method 1000 includes a step 1004 of communicating with a navigation managing system to determine whether a terrain map for the route is available. For example, in some embodiments, the navigation managing system is a network node, and the autonomous system may send a request to the network node, such as the network 108 of FIG. 1B. In an embodiment, the network node is a base station (e.g., eNB, gNB) and the autonomous system may send the request using cellular signals. In another embodiment, the network node is an access point of a wireless local area network, and the autonomous system may send the request using wireless signals (e.g., WiFi). In another embodiment, the network node is a roadside unit (RSU) and the autonomous system may send the request using short range wireless signals (e.g., dedicated short range communication signals).

In some embodiments, the navigation managing system is an Internet based vendor, and the autonomous system may send the request to a vendor that manages terrain maps for various autonomous systems. For example, the vendor may use cloud-based storage to store, maintain, and update terrain maps for various autonomous systems. In an embodiment, the autonomous system may send the request using Internet protocol. In another embodiment, the vendor's system includes a searchable graphical user interface, and the autonomous system may perform a search at the user interface to determine whether the vendor has a particular terrain map.

In some embodiments, the navigation managing system is another autonomous system, the autonomous system may send signals to determine whether another autonomous system has or is generating a terrain map. For example, the autonomous system may use various communication methods (e.g., WiFi, Bluetooth, etc.) to send signals targeting to nearby autonomous systems and wait for feedback signals. If the autonomous system does not receive any feedback signals within a predetermined time duration, the autonomous system may determine that the terrain map is unavailable. The signals may be broadcast signals or groupcast signals.

The method 1000 includes a step 1006 of generating the terrain map while navigating the route, in response to a determination that the terrain map is unavailable at the navigation managing system. For example, upon determination that the terrain map for the route is unavailable based on the communication with the network node, the vendor, or the one or more other autonomous systems, the autonomous system starts the navigation and generates a terrain map while navigating the route. For example, as the autonomous system navigates the terrain, it may continuously collect sensor data from a sensor system, such as the sensor system 116 of FIG. 1B. In some embodiments, the autonomous system may use one or more AI/ML models to process the sensor data and combine (fuse) data from multiple sensors to generate a terrain map. The terrain map can be any format of representations of the terrain features, for example, 1 D map, 2D map, 3D map, a colored map, a table including multiple data entries, multiple data sets, or an array of data, etc. The AI/ML models further identify an optimal path for the autonomous system based on the terrain map. In some embodiments, the autonomous system may generate the terrain map using a cloud-based computations, thereby reducing the computation load of the local processor.

The method 1000 includes a step 1008 of sending the generated terrain map to the navigation managing system. For example, in an embodiment, the autonomous system may transmit the generated terrain map to the network node, such as the network 108 of FIG. 1B. In an embodiment, the autonomous system may send the generated terrain map to the vendor, such as the vendor of FIG. 7. For example, the autonomous system may upload the generated terrain map based on the vendor's instructions so that the terrain map can be saved in a cloud-based storage of the vendor. In an embodiment, the autonomous system may send the generated terrain map to one or more other autonomous systems based on their requests.

In some embodiments, before sending the terrain map to another system, the autonomous system may compress the terrain map using one or more algorithms. In an embodiment, the autonomous system may use autoencoder to compress the terrain data. In this case, the autonomous system includes an encoder of the autoencoder for compression of the terrain map, and another system that receives the terrain map includes a decoder of the autoencoder for reconstruction of the terrain map. The autoencoder may have a structure in which the encoder and the decoder are symmetric. Each structure of the encoder and the decoder may include at least one of: multiple layers of multiple neural nodes, one or more neural nodes in each of the layers, one or more types of the layers, one or more connection architectures between the layers, one or more types of connections between the layers, one or more types of operations in each of the neural nodes, a weight of each of the neural nodes, one or more parameters of each of the neural nodes, or one or more loss functions of the neural nodes.

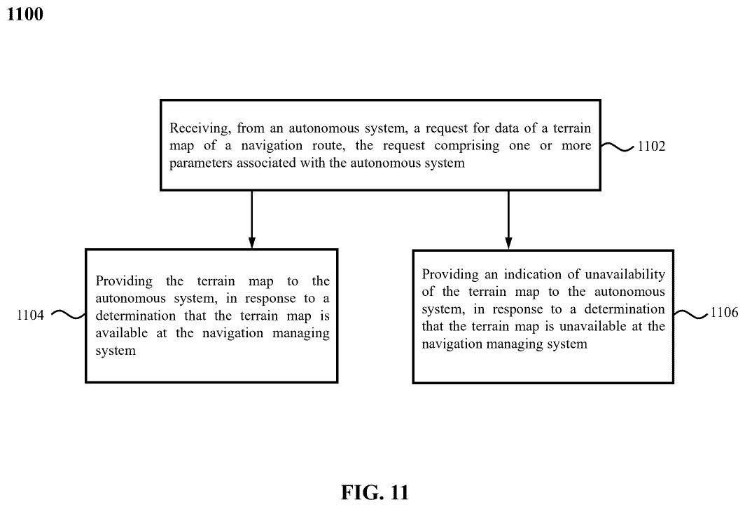

FIG. 11 is a schematic diagram illustrating a method for a navigation managing system, according to some embodiments of the present disclosure. The navigation managing system may take the responsibility of storing, maintaining, optimizing, updating, and providing terrain maps to various autonomous systems, such as the network 108 of FIG. 1A and FIG. 1B, the network 208 of FIG. 2A and FIG. 2B, the network 308 of FIG. 3A and FIG. 3B, the vendor of FIG. 7, and the AS 806 of FIG. 8. Referring to FIG. 11, a method 1100 includes a step 1102 of receiving, from an autonomous system, a request for a terrain map of a navigation route, the request comprising one or more parameters associated with the autonomous system. In an embodiment, the navigation managing system may receive the request by signals/data transmitted via various communication methods (cellular, WLAN, etc.). In another embodiment, the navigation managing system may receive the request via an inquiry or keywords entered through a graphical user interface of the terrain map managing system. In some embodiments, the request may include a starting point, an end point, and the type of the autonomous system.

The method 1100 includes a step 1104 of providing the terrain map to the autonomous system, in response to a determination that the terrain map is available at the navigation managing system. In some embodiments, the navigation managing system may optimize the terrain map based on the one or more parameters associated with the autonomous system before providing it to the autonomous system. In some embodiments, the navigation managing system may compress the terrain map before providing it the autonomous system. For example, the navigation managing system may compress the terrain map using an encoder of an autoencoder, such as the encoder 926 of FIG. 9.

The method 1100 includes a step 1106 of providing an indication of unavailability of the terrain map to the autonomous system, in response to a determination that the terrain map is unavailable at the navigation managing system. In some embodiments, the navigation managing system may send one or more feedback signals to indicate that the requested terrain map is unavailable. In some embodiments, the navigation managing system may output of an indication of unavailability on a graphical user interface of the navigation managing system. In some embodiments, the navigation managing system does not send any response to indicate that the requested terrain map is unavailable.

In some embodiments, after the step 1106, the method 1100 may further include a step (not shown) of receiving, from the autonomous systems, one or more terrain maps generated by the autonomous system. The received terrain maps may be compressed terrain maps and the navigation managing system may reconstruct the terrain map. For example, the navigation managing system may use a decoder of an autoencoder, such as the decoder 922 of FIG. 9.

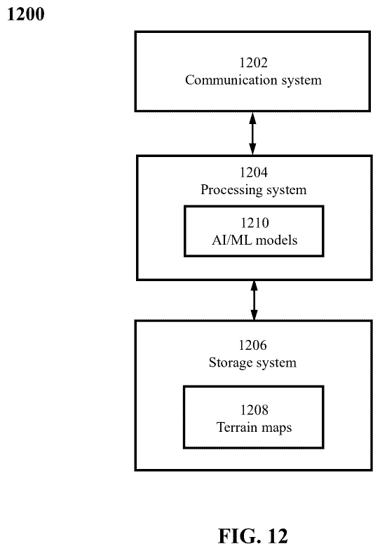

FIG. 12 is a block diagram of a navigation managing system, according to some embodiments of the present disclosure. The navigation managing system may take any form, including but not limited to, a computer, a mobile device, a distributed computing system, or any other form.

Referring to FIG. 12, the navigation managing system may include a communication system 1202. The communication system 1202 may include one or more antennas (not shown) that may be used for transmission or reception of electromagnetic signals to/from one or more other devices (e.g., an autonomous system). The one or more antennas may enable different input-output antenna configurations, for example, multiple input multiple output (MIMO) configuration, multiple input single output (MISO) configuration, and single input multiple output (SIMO) configuration. In some embodiments, one or more antennas may include multiple (e.g., tens or hundreds) antenna elements and may enable multi-antenna functions such as beamforming.

The communication system 1202 may include a transceiver (not shown) that is coupled to the one or more antennas. The transceiver may be a wireless transceiver at the navigation managing system and may communicate bi-directionally with other devices (e.g., an autonomous system). The transceiver may include a modem to modulate the packets and provide the modulated packets to the one or more antennas for transmission, and to demodulate packets received from the one or more antennas.

The navigation managing system 1200 includes a processing system 1204. The processing system 1204 may include one or more processors. Examples of the processors may include at least one of a general-purpose processor, a digital signal processor (DSP), a central processing unit (CPU), a graphical processing unit (GPU), etc. Examples of the general-purpose processor include, but are not limited to, a microprocessor, any conventional processor, a controller, a microcontroller, or a state machine. The processing system 1204 may receive, from the communication system 1202, signals/data further process the signals/data. In some embodiments, the processing system 1204 includes AI/ML models to process terrain maps received from autonomous systems. In some embodiments, at least one processor of the processing system 1204 is disposed remotely so that the navigation managing system can do some complicated computations remotely. In some embodiments, the processing system 1204 may also include an encoder and/or a decoder of an autoencoder.

The navigation managing system includes a storage system 1206. The storage system 1206 may be any type of computer-readable storage medium including volatile or non-volatile storage devices, or a combination thereof. The storage system stores terrain maps 1208. In some embodiments, at least a portion of the storage system 1206 is a cloud-based storage located remotely. In some embodiments, the AI/ML models 1210 are stored in the processing system 1204. In other embodiments, the AI/ML models 1210 are stored in the storage system 1206, rather than the processing system 1204. In some embodiments, the encoder and/or the decoder of the autoencoder are stored in the storage system 1206, rather than the processing system 1204.

The navigation managing system 1200 may also include output devices such as a display and/or a graphical user interface. The navigation managing system 1200 may also include input devices, such as, a keypad, a keyboard, a mouse, a scanner, a digital camera, a joystick, a trackball, cursor direction keys, a touchscreen monitor, or audio/video commanders, etc. The navigation managing system 1200 may also include a global positioning system (GPS), and/or a timer, etc. For the sake of simplicity, the descriptions of these well-known elements are omitted here.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not essential features of those embodiments, unless noted as such.

It will be further understood that various modifications, alternatives, and variations in the details, components, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

What is claimed is:

1. An autonomous system, comprising:
one or more computer-readable memories storing instructions; and
one or more processors coupled to the one or more computer-readable memories and configured to execute the instructions to:
determine a route for navigation;
communicate with a navigation managing system to determine whether a terrain map for the route is available; and
in response to a determination that the terrain map is unavailable at the navigation managing system, generate the terrain map while navigating the route.

2. The autonomous system of claim 1, wherein the autonomous system further comprises a sensor system including one or more sensors.

3. The autonomous system of claim 2, wherein the terrain map is generated using one or more artificial intelligence or machine learning (AI/ML) models based on sensor data collected by the one or more sensors.

4. The autonomous system of claim 1, wherein the one or more processors are further configured to execute the instructions to:
send the generated terrain map to the navigation managing system.

5. The autonomous system of claim 1, wherein the one or more processors are further configured to execute the instructions to:
compress the generated terrain map using at least one compression algorithm; and
send a compressed terrain map to the navigation managing system.

6. The autonomous system of claim 5, wherein the at least one compression algorithm comprises an autoencoder.

7. The autonomous system of claim 1, wherein the navigation managing system comprises at least one of:
a network node configured to communicate with the autonomous system using wireless signal,
a vendor configured to communicate with the autonomous system via Internet, or
one or more other autonomous systems configured to communicate with the autonomous system.

8. The autonomous system of claim 1, wherein the one or more processors are further configured to execute the instructions to:
in response to a determination that the terrain map is available at the navigation managing system, obtain the terrain map from the navigation managing system; and
perform the navigation based on the obtained terrain map.

9. A computer-implemented method for an autonomous system, comprising:
determining a route for navigation;
communicating with a navigation managing system to determine whether a terrain map for the route is available; and
in response to a determination that the terrain map is unavailable at the navigation managing system, generating the terrain map while navigating the route.

10. The method of claim 9, wherein generating the terrain map while navigating the route comprises:
training one or more artificial intelligence or machine learning (AI/ML) models using sensor data collected by one or more sensors of the autonomous system.

11. The method of claim 9, further comprising:
sending the generated terrain map to the navigation managing system.

12. The method of claim 11, further comprising:
compressing the generated terrain map using at least one compression algorithm; and
sending a compressed terrain map to the navigation managing system.

13. The method of claim 12, wherein the at least one compression algorithm comprises an autoencoder.

14. The method of claim 9, wherein the determining whether the terrain map is available further comprises:
transmitting a request signal to the navigation managing system, the request signal comprising an indication of the route, and at least one of: a type of the autonomous system, at least one parameter related to weather condition, at least one size of the autonomous system, at least one functional feature of the autonomous system, or a type of work needs to be done by the autonomous system during navigation; and
receiving a feedback signal from the navigation managing system.

15. The method of claim 9, wherein the determining whether the terrain map is available further comprises:
inputting an inquiry on a user interface provided by the navigation managing system, the inquiry comprising an indication of the route, and at least one of: a type of the autonomous system, at least one parameter related to weather condition, at least one size of the autonomous system, at least one functional feature of the autonomous system, or a type of work needs to be done by the autonomous system during navigation; and
receiving a response from the navigation managing system.

16. A navigation managing system, comprising:
one or more computer-readable memories storing instructions; and
one or more processors coupled to the one or more computer-readable memories and configured to execute the instructions to:
receive, from an autonomous system, a request for a terrain map of a navigation route, the request comprising one or more parameters associated with the autonomous system;
in response to a determination that the terrain map is available at the navigation managing system, provide the terrain map to the autonomous system; or
in response to a determination that the terrain map is unavailable at the navigation managing system, provide an indication of unavailability of the terrain map to the autonomous system.

17. The navigation managing system of claim 16, wherein the one or more processors are further configured to execute the instructions to:
receive, from the autonomous system, the terrain map generated by the autonomous system while navigating the navigation route.

18. The navigation managing system of claim 17, wherein the terrain map received from the autonomous system is a compressed terrain map, and the one or more processors are further configured to execute the instructions to:
reconstruct the terrain map based on the compressed terrain map using at least one algorithm, the at least one algorithm comprising an autoencoder.

19. The navigation managing system of claim 16, wherein the one or more processors are further configured to execute the instructions to:
in response to a determination that the navigation managing system has the requested terrain map, optimize the terrain map based on the one or more parameters associated with the autonomous system; and
provide an optimized terrain map.

20. A computer-implemented method for a navigation managing system, comprising:
receiving, from an autonomous system, a request for a terrain map of a navigation route, the request comprising one or more parameters associated with the autonomous system;
in response to a determination that the terrain map is available at the navigation managing system, providing the terrain map to the autonomous system; or
in response to a determination that the terrain map is unavailable at the navigation managing system, providing an indication of unavailability of the terrain map to the autonomous system.
